(19) United States
(12) Patent Application Publication
(10) Pub. No.: US 2013/0069324 A1
(43) Pub. Date: Mar. 21, 2013

(54) WHEELED BOWLING BALL CARRIER ASSEMBLY WITH ANTI-TWIST STABILIZING AND SUPER-CLIMBING OBSTACLE-NAVIGATING PROPERTIES

(71) Applicants: Catherine Weibel, Winter Park, FL (US); Amy Graller, Highland Park, IL (US); Martha Armes, Tampa, FL (US)

(72) Inventors: Catherine Weibel, Winter Park, FL (US); Amy Graller, Highland Park, IL (US); Martha Armes, Tampa, FL (US)

(21) Appl. No.: 13/234,588

(22) Filed: Sep. 16, 2011

(51) Int. Cl. B62B 1/00

(52) U.S. Cl. 280/47.26

(57) ABSTRACT

A wheeled bowling ball carrier or SCAT-carrier assembly, has a rigid frame enclosed by fabric or other material to protect and transport bowling balls and related equipment and other items. The configuration of the interior of the bag is made by the user with the insertion of any number of storage inserts, each of which may accommodate one or more items, and is secured to the interior floor of the bag with hook and loop tape. The frame is equipped with stops to accommodate an upright position for the SCAT-carrier assembly, and a retractable handle. The frame has an axle terminated at each end by a hub-and-wheel assembly, each assembly having three uniformly, angularly spaced to form an equilateral triangular configuration, the three wheels collectively rotating on each of the hubs and each wheel also independently rotating, and allowing for indexing, either together or independently, upon encountering an obstacle, such as uneven terrain, curbs or stairs.

### BACKGROUND OF THE INVENTION

1. Field of the Invention

The present invention generally concerns carriers to protect and transport bowling equipment, and in particular, wheeled ball carriers used for the prevention of pain, discomfort and injury to the musculoskeletal systems of the human body caused or exacerbated by lifting, pulling or otherwise transporting equipment and accessories related to bowling activities.

2. Description of the Prior Art

Symptoms of ailments and injuries specific to the aforementioned system of the human body may be:
Caused by a single, or repeated, incident(s) resulting in discomfort, pain or injury to a user while transporting bowling equipment
Pre-existing and therefore exacerbated by activities such as described above, and
   temporary in nature, that is caused by a trauma, illness or surgical procedure, and thus require attention during a rehabilitative process
   chronic in nature, that is needing to be managed consistently over the long term

Some of the pre-existing medical conditions that are affected by lifting or pulling heavy equipment are as follows: post surgical conditions (open heart surgery), varicose veins, osteoporosis/osteopenia, vertigo, stroke, and various symptoms or secondary injury/conditions that are aggravated by lifting are as follows:
Musculoskeletal injury (Back/neck/shoulder/elbow/wrist/hand)
Circulatory/mastectomy
Diabetic or other neuropathy
Neurological impairments

In the human body, the brain initiates motor movement to obtain a certain outcome in daily repetitive or sustained tasks such as lifting a bag or a suit case. When a human being lifts heavy items, there is a chain of neurological events involved from the brain to the working muscles. If the object is too heavy or causes strain on any region of the body, injury may occur in any body part from the low back to the wrist.

Specifically, the mechanism of lifting a bowling ball bag begins in the brain to initiate the task. The person uses the lumbar spine for stability and balance, and the cervical and shoulder complex absorb the gravitational forces caused by the weight of the object. The elbow, wrist and hand adapt to the stress that occurs at these joints and the object is able to be moved. Repetitive lifting of any object may place stress and strain on the involved structures. Given the weight of bowling balls in a bowling bag, the repetitive stress on the body's structures is unusually large compared to other tasks, as the weight of the average single bowling ball and a rolling bag is approximately 23 pounds, and the weight of 6 balls and a rolling bag is approximately 108 pounds. When lifted, forces are applied unevenly to mainly the lifting side of the human body, secondary to habit or hand dominance. This causes asymmetrical strain that is proportional to the weight of the objects being lifted or carried. Repeated lifting and extended periods of time carrying heavy equipment up stairs or over obstacles increase this strain on the back, neck, shoulder complex, elbow, wrist and hand. Various conditions may occur secondary to the stress and strain the body endures such as low back, thoracic or cervical strains, herniated discs and thoracic outlet syndrome. Also noted are stress on the brachial plexus, and various inflammatory conditions such as biceps tendonitis, lateral epicondylitis and Dequervain's tenosynovitis,

It is, therefore, imperative to address the challenge of reducing the requirement for lifting an object such as a bowling bag to promote ease and comfort in a task that may cause unnecessary injury or discomfort. The creation of a bowling ball carrier with an indexing wheel mechanism enables the user to avoid excessive lifting/carrying, serving to decrease the gravitational forces acting on the low back, thoracic and cervical regions, as well as the shoulder, elbow, wrist and hand. By creating a bowling ball carrier which allows the user to pull a full load of bowling equipment using proper posture and increased joint/core stability, the likelihood of injury is vastly decreased. The indexing wheel assembly climbs curbs or stairs with decreased pressure on the joints previously mentioned. The stability of an indexing wheel assembly serves to prevent the ball carrier from tipping/twisting upon hitting an obstacle while being pulled. Such an event causes stress specifically to the wrist, elbow and shoulder, and there exists a disproportionate percentage of traumatic injuries from tipping/twisting among bowlers. Generally, this mechanism allows the bowler to conserve energy and avoid injury during normal sporting travel.

There is a well-documented need for wheeled and non-wheeled bags that perform at least one of the following functions:
transport heavy bowling equipment in a manner that protects the user from exacerbating pain or discomfort from an existing pathology or injury, such as traumatic injury, a surgical procedure, etc. . . .
pad or protect various contents of the bag, including bowling balls, shoes/clothing, accessories, laptop or other scoring device, personal belongings etc. . . . while storing or transporting such items
allow for a variation in the number of bowling balls and related paraphernalia stored or transported by the user on an as-needed basis,

A number of products are known that have attempted to address these needs for the protection from, prevention and alleviation of symptoms related to lifting.

Among these is the standard zippered bowling ball storage bag, which is a canvas or leather bag, which may be lifted and carried over the shoulder by a strap, or may be attached to a metal wheeled frame and wheeled along a generally flat surface. Such bags are readily available on the market in models designed to carry 1, 2, 3, 4 and 6 bowling balls, and optionally, bowling shoes and personal items. Several existing bags have attempted to address issues related to both the stability of the bag while wheeling or standing upright, and challenges in navigating over obstacles while being pulled. In addressing instability issues, some existing products have incorporated wheels that are larger in diameter than the majority of bags, and set the wheels slightly farther apart. While this does address stability over relatively flat terrain, any event which upsets the equal horizontal level of the wheels carries a risk of tipping the bag, and therefore twisting and injuring the user's wrist. Additionally, a higher center of gravity of the load increases this risk of tipping/twisting, with the greatest risk from the popular “tower style” bag, which stacks 3 bowling balls vertically in the bag. While larger wheels do serve to increase the height of obstacles which may be cleared by a wheeled bag, they do not address the prevention of injuries related to tipping or twisting of the bag when wheeled. There are no existing cases where a flight of stairs is addressed as an obstacle navigable by design. While initially providing workable solutions, these products are ineffective due to:
the instability of bags addressing issues with a design requiring level wheels relative to each other and with the axle parallel to the wheeling surface. These applications gain only marginal effectiveness with increased wheel diameter. Existing examples have wheels measuring only up to approximately five (5) inches in diameter, and with the secondary increase in the center of gravity of the bag, actually increase the tipping risk.
the lack of solutions which effectively address the use of the product over an uneven wheeling surface, and obstacles such as stairs, curbs, etc. . . . These products still require lifting over curbs, and carrying on stairs, which may be physically impossible given the total load. (One such product is disclosed in United States Patent Application Publication No: US2002/0113386)
the lack of products designed to protect the user and prevent injuries, such as twisting of the wrist, which are directly related and commonly suffered from pulling wheeled bowling bags (one such product is disclosed in United States Patent Application Publication No. US2002/0113386)
the cumbersome, complicated systems for achieving user-configured storage flexibility (as disclosed in United States Patent Application Publication No. US2008/0093238, U.S. Pat. No. 5,791,469)

None of the numerous products in the patent process, or already available in the market, achieves any stability property that sufficiently addresses the issue of tipping/twisting, nor does any address obstacle navigating properties on obstacles such as stairs or curbs.

### SUMMARY OF THE INVENTION

It is an object of the present invention, herein referred to as the Super Climbing Anti-Twist (SCAT) assembly, to provide a wheeled bowling ball carrier that addresses the above issues in a unique and more effective manner than currently available bowling bags. In addition, the present invention addresses previously unaddressed issues pertaining to the need for stability, preventing tipping/twisting, navigating obstacles, climbing stairs and independent operation of each of two wheel hubs while being wheeled or standing upright.

This object is achieved in accordance with the present invention by a wheeled bowling ball carrier that is formed by a static frame joined to an indexing wheel assembly in a hub-and-axle connection. The indexing wheel assembly is comprised of two hubs, each with three evenly spaced wheels, forming a triangular configuration. Smooth operation of the ball carrier while being wheeled is achieved by the use of friction resistant technology such as ball bearings. The frame may be enclosed so as to form a closed container, such as a bag. The interior of the bag can have hook and loop tape attachments to secure any of a number of inserts to the bottom surface of the bag, achieving full user configurability of the internal storage cavity as desired. To provide the option of carrying the bag, carrying handles or an adjustable shoulder strap may be attached to the bag. One or two stops are attached to the underside of the frame to allow vertical stability when the carrier is not being wheeled. A retractable handle allows for the comfortable pulling of the carrier for users of a wide variety of heights. The SCAT-carrier assembly may be easily wheeled within the home or bowling facility over either smooth surfaces, over obstacles such as curbs, or on a flight of stairs. The ability of the wheel assembly of the SCAT-carrier assembly to allow independent operation of each hub provides un-paralleled stability and resistance to tipping/twisting.

Compared to existing products, the SCAT-carrier assembly exhibits superior stability, user-set configurability, and the facility to operate over curbs, obstacles or stairs, thereby making the SCAT-carrier assembly much more amenable to use in the storage, protection and transportation of bowling balls and related equipment. Particular attention is paid to the prevention of new, or exacerbation of existing, injuries or pathologies experienced by a user, with causes directly related to bowling activities. Because the hubs of the indexing wheel assembly can operate independently on uneven surfaces, over curbs or on stairs, users are, for the first time, able to transport bowling equipment in a solution that addresses the prevention of injury to the user, navigation of uneven terrain and navigation over curbs and stairs, where previously no solution existed.

The SCAT-carrier assembly can be made available in various heights, widths, and lengths so as to provide a range of models that satisfy the equipment requirements of all bowling activities. The versatility and configurability of the SCAT-carrier assembly allows the user a significant degree of customization to configure the storage cavity of the SCAT-carrier assembly to provide each person with the most appropriate configuration that simultaneously maximizes the ability to navigate surfaces that are not level and minimizes the introduction of new, or exacerbation of existing, pain, discomfort, or other physical symptoms.

### BRIEF DESCRIPTION OF THE DRAWINGS

FIG. 1 is a front view of the SCAT-carrier assembly in accordance with the present invention with the frame, handle and wheel assembly components.

FIG. 2 is a side view of the SCAT-carrier assembly in accordance with the present invention, with views of the retractable handle, bag, frame and hub/wheel components and angled at a degree theta at which a typical user would place it while in operation.

FIG. 3 is a back view of the SCAT-carrier assembly in accordance with the present invention showing detailed construction of how the frame and retractable handle are configured and ultimately concealed by the bag.

FIG. 4 is a front view of the SCAT-carrier assembly in accordance with the present invention, standing upright, and showing a sample configuration of the use of various possible protective storage inserts, which are held in place with hook and loop tape tabs secured to the inside of the bag.

FIGS. 5a, 5b, 5c and 5d are front views of various individual storage inserts for the SCAT-carrier assembly in accordance with the present invention, for use in storing and protecting bowling balls, shoes/clothing, personal effects, scoring systems and other paraphernalia associated with bowling activities.

FIG. 6 is a side view of the SCAT-carrier assembly in accordance with the present invention, showing a detail of the hub and wheel assembly.

FIG. 7 shows a side view detail of one hub and wheel assembly.

### DESCRIPTION OF THE PREFERRED EMBODIMENTS

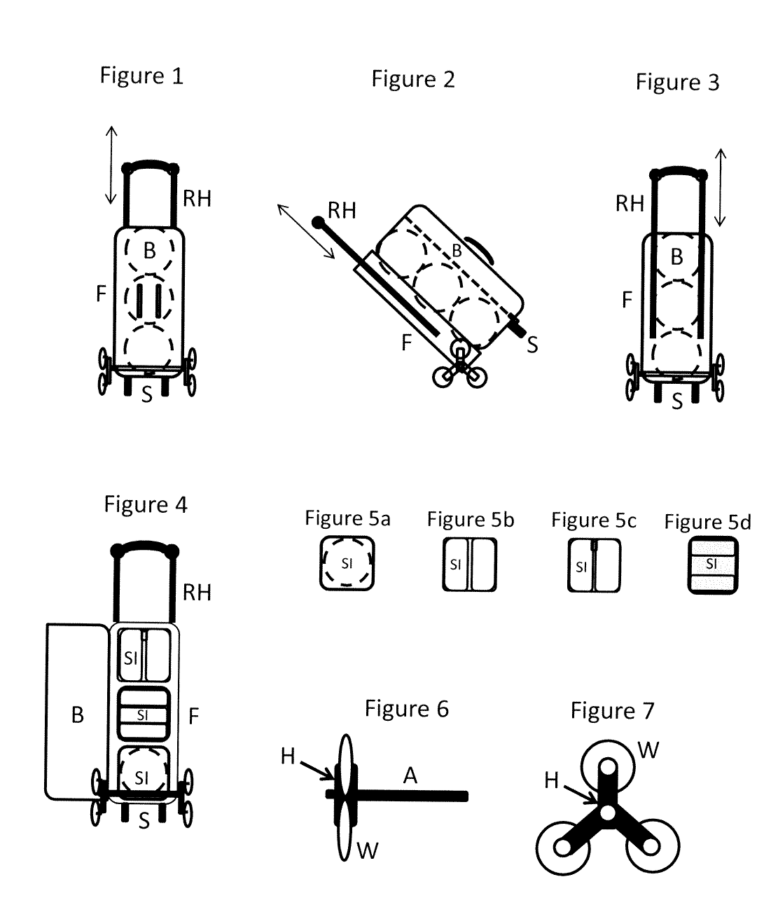

FIG. 1 shows a front view of a SCAT-carrier assembly in accordance with the invention. The SCAT-carrier assembly has a frame F. The frame F is designed (dimensioned) to hold one or more regulation size bowling balls (indicated with dashed lines). Stops are integrated into the lower member of the frame F to support the full SCAT-carrier assembly while upright. A handle, such as a retractable handle RH, for pulling may be provided, that is selectively adjusted by the user.

The frame F may be provided with an enclosure, such as a bag B, which rests on the lower member of the frame F. The bag B may be formed of any suitable material, such as fabric, canvas, leather or any such material appropriate for the protection or transportation of bowling equipment.

FIG. 2 shows how the SCAT-carrier assembly would be angled by the average user to comfortably and safely pull the SCAT-carrier assembly and its contents.

FIG. 3 shows a back view of a SCAT-carrier assembly in accordance with the invention and how the retractable handle RH is stored in, and concealed by, the bag B and frame F.

The interior of the SCAT-carrier assembly shown in FIG. 1 is able to be configured by the user with a number of available storage inserts SI. One such configuration is shown in FIG. 4. Individual storage inserts SI, a few samples of which are shown in FIG. 5a to store a bowling ball, 5b to store shoes or clothing, 5c to store small personal items and 5d to store a laptop computer or scoring equipment, where the inserts SI may be selected and combined by the user on as as-needed basis as shown in FIG. 4.

FIG. 6 shows a front view detail of one hub H and wheel W assembly, two of which are connected by an axle A. The axle A is non-rotatably attached to the bottom (when the Frame F is upright) of the frame F.

FIG. 7 shows a side view detail of one hub H and wheel W assembly, showing the uniformly angularly spaced triangular configuration of the wheels W on the hub H, as each wheel rotates independently about its own axle joining it to the hub H itself. As indicated by the smaller curved double arrows, each of the three wheels W is independently rotatable around its own axle, the respective axles of the wheels W being connected to struts of the hub H. As indicated by the larger curved double arrow, the three wheels W are collectively rotatable together and simultaneously around a center of the hub H, and thus around the non-rotatable axle A.

Although modifications and changes may be suggested by those skilled in the art, it is the intention of the inventors to embody within the patent warranted hereon all changes and modifications as reasonably and properly come within the scope of their contribution to the art.

We claim as our invention:

1. A wheeled bowling ball carrier, comprising:
a frame having a size dimensioned to transport at least one regulation bowling ball, said frame being manually transportable and being positionable in an upright position and, when in said upright position, having a frame bottom;
one axle non-rotatably mounted to said frame beneath said frame bottom, said one axle having opposite terminating ends;
two wheel assemblies respectively located at said opposite terminating ends of said axle;
each of said wheel assemblies comprising a hub having a hub center at which the hub is rotatably mounted to one of the terminating ends of the axle, and three wheels spaced at uniform angular rotations around said hub center, and rotatably mounted to said hub by respective wheel axles so that each wheel is independently rotatable around its wheel axle; and
a manually grippable handle attached to said frame allowing said frame to be pulled along a surface with respect to which each of said wheel assemblies, and each of the three wheels thereof, is free to rotate.

2. A wheeled bowling ball carrier as claimed in claim 1, comprising:
an enclosure attached to said frame having a size dimensioned to contain and enclose said at least one regulation bowling ball.

3. A wheeled bowling ball carrier as claimed in claim 2 wherein said enclosure is a bag.

4. A wheeled bowling ball carrier as claimed in claim 2 wherein said enclosure is comprised of fabric, canvas, leather or any such material appropriate for the protection or transportation of bowling equipment.

5. A wheeled bowling ball carrier as claimed in claim 2 comprising at least one insert that is removably attachable to said enclosure.

6. A wheeled bowling ball carrier as claimed in claim 5 wherein said insert is configured to contain said at least one regulation bowling ball.

7. A wheeled bowling ball carrier as claimed in claim 5 wherein said insert is configured to contain and enclose an item other than said at least one regulation bowling ball.

8. A wheeled bowling ball carrier as claimed in claim 5 wherein said insert is attached at an interior of said enclosure.

9. A wheeled bowling ball carrier as claimed in claim 5 wherein said insert is attached at an exterior of said enclosure.

10. A wheeled bowling ball carrier as claimed in claim 5 comprising at least one hook-and-loop fastener that attaches said insert to said enclosure.

11. A wheeled bowling ball carrier as claimed in claim 1 wherein said handle is a retractable handle that retracts within said frame when not in use.

12. A wheeled bowling ball carrier as claimed in claim 1 comprising a shoulder strap attachable to said frame.
